(19) United States
(12) Patent Application Publication
(10) Pub. No.: US 2011/0182644 A1
(43) Pub. Date: Jul. 28, 2011

(54) IMAGE FORMING APPARATUS AND DISPLAY CONTROL METHOD

(75) Inventors: Seiji Tsuduki, Saitama-ken (JP); Ryota Kashiwagi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/015,067

(22) Filed: Jan. 27, 2011

Related U.S. Application Data
(60) Provisional application No. 61/299,070, filed on Jan. 28, 2010.

(51) Int. Cl. B41J 11/42

(52) U.S. Cl. 400/583

(57) ABSTRACT

An image forming apparatus includes plural detection parts, a storage part and a display part. The detection parts are respectively installed at specific positions in the image forming apparatus, and respectively detect whether sheet clogging occurs. The storage part stores data of a transmitted image of the image forming apparatus. The display part acquires the data of the transmitted image of the image forming apparatus from the storage part, and displays the data of the transmitted image, and further displays position information indicating installation places of the respective detection parts on the transmitted image, and emphasizes and displays position information corresponding to the detection part which now detects the sheet clogging.

### CROSS-REFERENCE TO RELATED APPLICATION

This application is based upon and claims the benefit of priority from: U.S. provisional application 61/299,070, filed on Jan. 28, 2010; the entire contents all of which are incorporated herein by reference.

### FIELD

Embodiments described herein relate generally to a display technique of a display screen to which reference is made at the time of maintenance of an image forming apparatus.

### BACKGROUND

In an image forming apparatus, when maintenance is performed, a screen for maintenance is displayed on a control panel, and a person in charge of maintenance works while referring to the screen for maintenance.

Besides, hitherto, at the time of sheet clogging (hereinafter referred to as JAM) in an image forming apparatus, the position of an open and close cover for removing the JAM is displayed on the control panel as JAM mark, and first, a general user attempts to remove the JAM while referring to the control panel. When the general user cannot determine where the JAM occurs in the image forming apparatus, he or she contacts a support center of a manufacture maker of the image forming apparatus, and a person in charge in the support center, that is, a person in charge of maintenance refers to the JAM mark and removes (repairs) the JAM. When the removal operation is performed, the person in charge of maintenance works while confirming which sensor detects the JAM.

However, there is a case where the person in charge of maintenance can not instantly determine where the sensor exists based on only the JAM mark correlated with the open and close cover, and can not specify the position of the sensor unless reference is made to a maintenance manual or the like. In this case, there is a problem that it takes long time to remove the JAM.

Besides, in the image forming apparatus of the related art, the trouble of once turning off a power source is also required in order to switch a mode used by the general user to a mode for maintenance.

### DESCRIPTION OF THE DRAWING

FIG. 1 is a schematic view showing an image forming apparatus.

FIG. 2 is a view showing an example of a function block of an image forming apparatus of a first to a third embodiment.

FIG. 3 is a view showing an example of a correspondence table stored in a storage part of the first embodiment.

FIG. 4 is a flowchart showing an example of an operation of the image forming apparatus of the first to the third embodiment.

FIG. 5 is a view showing a display example in a general user mode in the image forming apparatus of the first to the third embodiment.

FIG. 6 is a view showing an example in which the whole apparatus is displayed when the image forming apparatus of the first to the third embodiment is in a maintenance mode.

FIG. 7 is a view showing a detailed display example when the image forming apparatus of the first to the third embodiment is in the maintenance mode.

FIG. 8 is a view showing a guide display example when the image forming apparatus of the first to the third embodiment is in the maintenance mode.

FIG. 9 is a view (with a guidance) showing a guide display example when the image forming apparatus of the first to the third embodiment is in the maintenance mode.

FIG. 10 is a view showing an example of a correspondence table stored in a storage part of the second embodiment.

FIG. 11 is a view showing an example of a sensor list display of the image forming apparatus of the third embodiment.

FIG. 12 is a block diagram showing a structural example of an image forming apparatus of a fourth embodiment.

FIG. 13 is a flowchart showing an example of an operation of the image forming apparatus of the fourth embodiment.

FIG. 14 is a view (D1, D2 screen) showing a display example of the image forming apparatus of the fourth embodiment.

FIG. 15 is a view (D3, D4 screen) showing a display example of the image forming apparatus of the fourth embodiment.

### DETAILED DESCRIPTION

According to an aspect, an image forming apparatus includes plural detection parts, a storage part and a display part. The detection parts are respectively installed at specific positions in the image forming apparatus and respectively detect whether sheet clogging occurs. The storage part stores data of a transmitted image of the image forming apparatus. The display part acquires the data of the transmitted image of the image forming apparatus from the storage part, and displays the data of the transmitted image, and further displays position information indicating installation places of the respective detection parts on the transmitted image, and emphasizes and displays the position information corresponding to the detection part which now detects the sheet clogging.

### First Embodiment

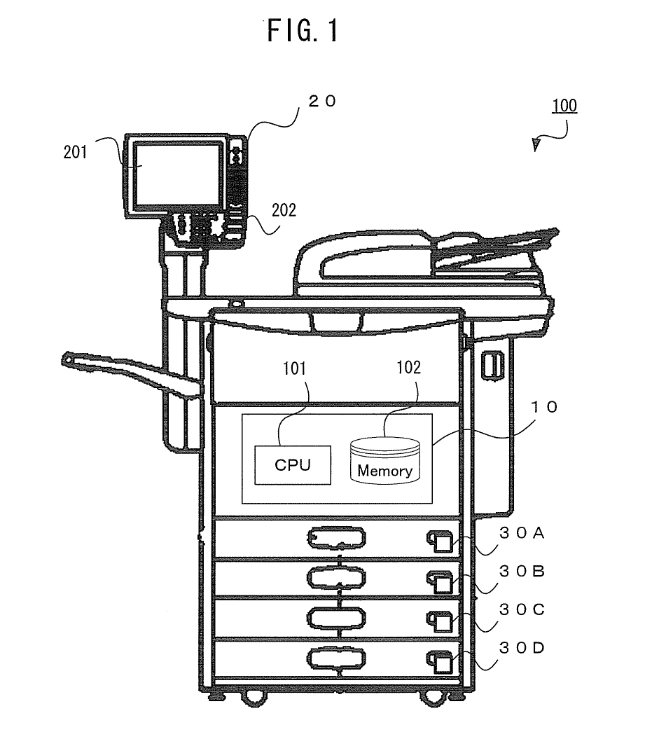

FIG. 1 is a schematic view showing a main structure of an image forming apparatus of an embodiment. The image forming apparatus 100 includes a controller 10, a control panel 20, and sensors 30A to 30D.

The controller 10 is a device to overall control the hardware of the image forming apparatus 100, and includes a CPU 101 as a central processing unit and a MEMORY 102 as a storage device. The MEMORY 102 can be formed of, for example, a RAM (Random Access Memory), a ROM (Read Only Memory), a DRAM (Dynamic Random Access Memory), an SRAM (Static Random Access Memory), a VRAM (Video RAM), a flash memory or the like, and has a function to store various information and programs used in the image forming apparatus 100.

The control panel 20 is a device which displays a processing state, an error state and the like of the image forming apparatus 100, and receives a processing start instruction from a user and an input of parameters such as the number of sheets to be processed, and includes a touch panel display 201 and a keyboard 202.

The sensors 30A to 30D are sensors to detect sheet clogging. In the example of FIG. 1, although the sensors 30A to 30D are set at positions where sheets are fed from cassettes, a sensor is set at each place where it is estimated that sheet clogging occurs.

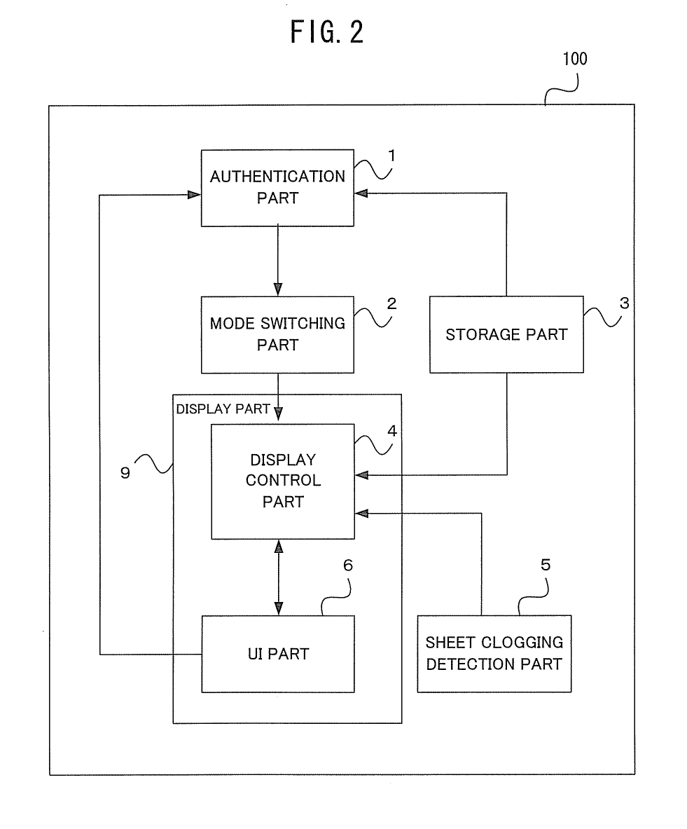

FIG. 2 is a block diagram showing an example of a function provided in the image forming apparatus 100. The image forming apparatus 100 includes, for example, an authentication part 1, a mode switching part 2, a storage part 3, a display part 9 and a sheet clogging detection part 5. The display part 9 includes a display control part 4, a UI part 6 (UI: User Interface) and the like.

The authentication part 1 determines whether a specified password is inputted through the UI part 6. When the determination by the authentication part 1 is affirmative, that is, the specified password is inputted, the mode switching part 2 switches a mode (normal mode) for general user to a mode for maintenance. On the other hand, when the work in the maintenance mode is ended, the maintenance mode is switched to the mode for general user by a specified operation.

The storage part 3 corresponds to the MEMORY 102, and stores respective image data used in the embodiment and the specified password. Besides, the storage part 3 stores a table in which sensor numbers corresponding to the sensors 30A to 30D, identification information of detailed image data as detailed images of the peripheries of the sensors, and identification information of procedure image data in which procedures of removing the JAM are described are correlated with one another.

The display control part 4 acquires notification, which is transmitted when sheet clogging occurs, from the sheet clogging detection part 5. The display control part 4 changes an image to be displayed in accordance with the input from the user through the UI part 6. The details of the operation of the display control part 4 will be described later.

The sheet clogging detection part 5 is a function part constituted by the sensors 30A to 30D, and notifies the display control part 4 which of the sensors 30A to 30D detects sheet clogging. The UI part 6 is a function part to receive the input from the user and to notify the user, and corresponds to the control panel 20.

The authentication part 1, the mode switching part 2 and the display control part 4 are realized by the controller 10. That is, they are realized in such a way that software previously stored in the MEMORY 102 is executed by the CPU 101, and data stored in the MEMORY 102 is used.

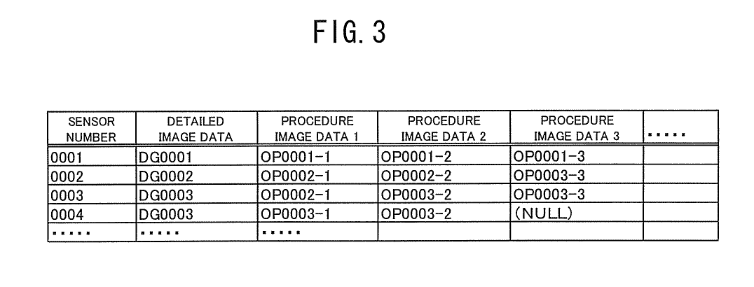

Next, FIG. 3 shows a correspondence table stored in the storage part 3 in the first embodiment. The identification number of detailed image data, and the identification numbers of respective procedure image data are correlated with one another for each sensor number and are stored in the storage part 3. Incidentally, in this embodiment, the identification number is the file name of the image data.

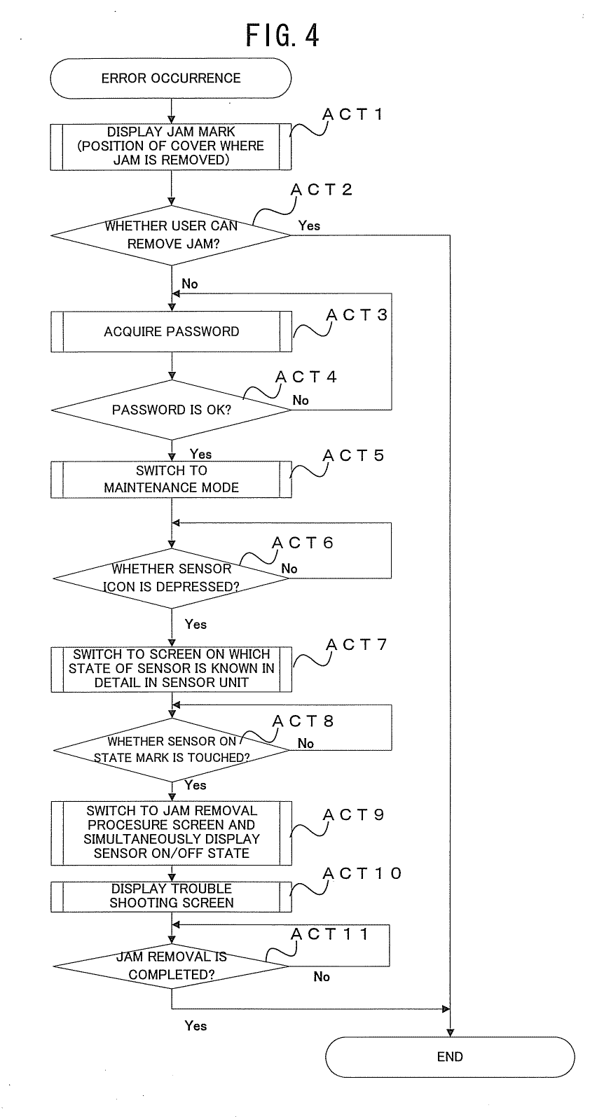

Next, the operation of the image forming apparatus 100 will be described with reference to a flowchart of FIG. 4. The respective operations in the image forming apparatus 100 are realized by causing the CPU 101 to execute programs stored in the MEMORY 102.

When JAM occurs and one of the sensors 30A to 30D detects this (the sensor is switched from OFF to ON), the sheet clogging detection part 5 notifies the display control part 4 which sensor detects the JAM.

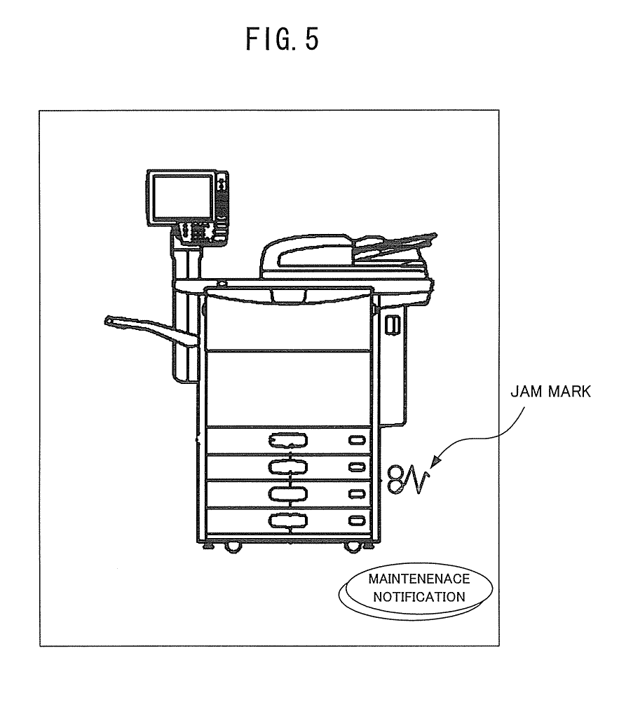

The display control part 4 causes the UI part 6 to display a maintenance notification button and the whole view of the image forming apparatus 100. Besides, the display control part 4 causes a JAM mark to be displayed at a position of an open and close cover in the vicinity of a place where the JAM occurs (ACT1). FIG. 5 shows a display example of the UI part 6 at this time. FIG. 5 shows the example in which the JAM occurs in the cassette part, and the JAM mark is displayed at the position of the cover to open and close the whole cassette part.

The general user opens the open and close cover of the cassette part while referring to this JAM mark, and performs a sheet removal operation. Here, when the sheet is removed by the general user (ACT 2, Yes), the process is ended. On the other hand, when the general user can not remove the sheet, and the maintenance notification button is depressed (ACT 2, No), notification is made to the support center of the image forming apparatus 100.

The authentication part 1 acquires a password inputted by the person in charge of maintenance through the UI part 6 (ACT 3). The authentication part 1 compares a password stored in the storage part 3 with the inputted password, and authenticates. When the inputted password is the regular password (ACT 4, Yes), the mode switching part 2 switches the mode for general user to the maintenance mode (ACT 5).

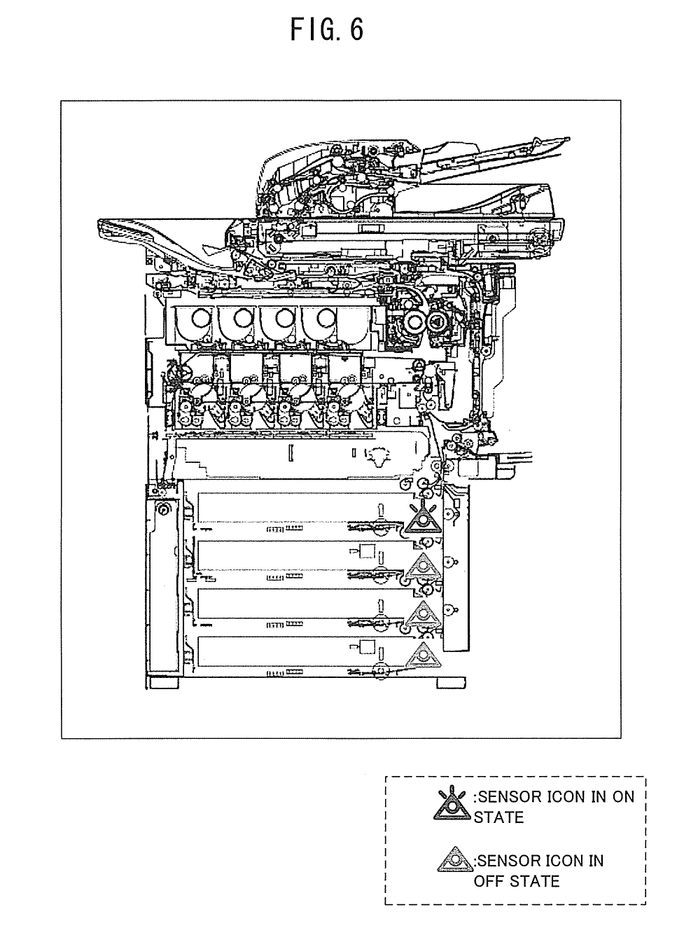

After the mode is switched to the maintenance mode, as shown in FIG. 6, the display control part 4 controls the display of the UI part 6 to display image data of the whole image forming apparatus 100, in which the image forming apparatus 100 is transparent. Besides, the display control part 6 controls the display of the UI part 6 so that sensor icons (position information) are arranged at positions where the sensors are installed, and controls so that the icon of the sensor (the sensor 30A in this example), which detects the occurrence of the JAM, is emphasized and displayed. In the example of FIG. 6, the display control part 4 controls the display so that the patterns of the icons are different between the sensor (ON sensor) which detects the occurrence of the JAM and the sensor (OFF sensor) which does not detect. However, the display may be controlled so that the ON sensor blinks, or the color thereof varies.

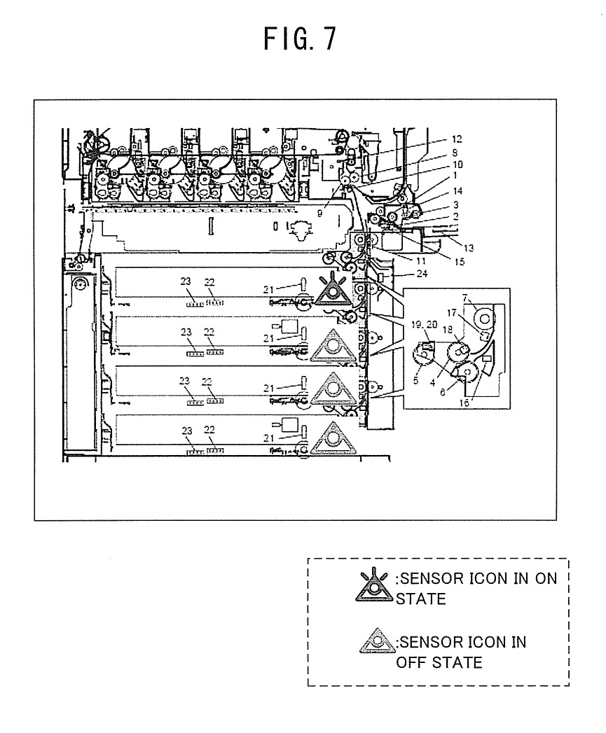

The display control part 4 stands by until the person in charge of maintenance depresses the sensor icon (ACT 6, No). When the person in charge of maintenance depresses the sensor icon (ACT 6, Yes), the display control part 4 switches the display from the whole image shown in FIG. 6 to the detailed image data of the periphery of the sensor (ACT 7). In this example, it is assumed that the ON sensor icon of FIG. 6 is depressed, and the transmitted detailed image data is displayed as shown in FIG. 7. At this time, the display control part 4 acquires the detailed image data corresponding to the ON state sensor by referring to the correspondence table (FIG. 3) stored in the storage part 3, and controls so that the acquired detailed image data is displayed.

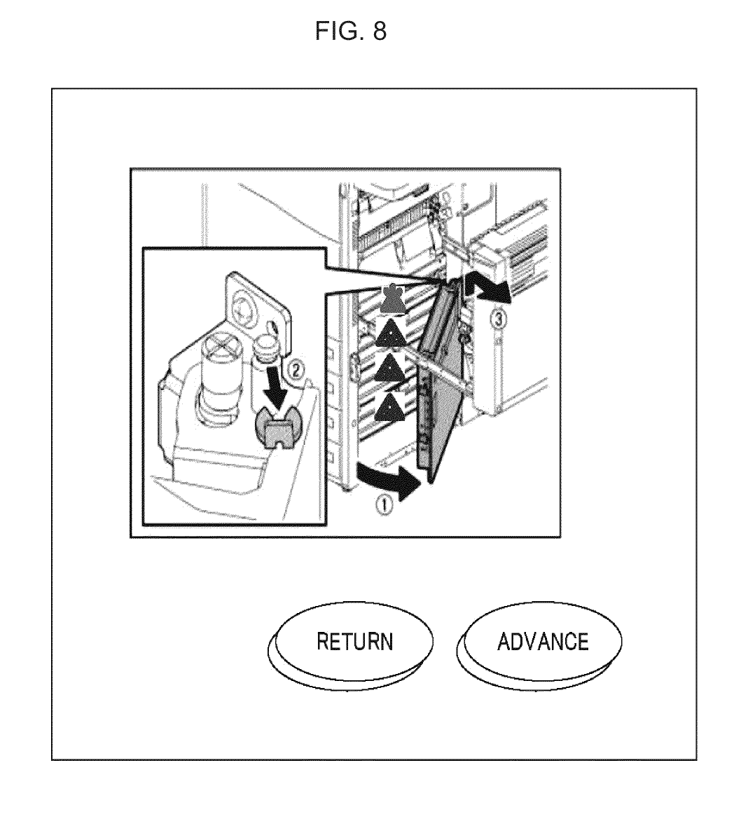

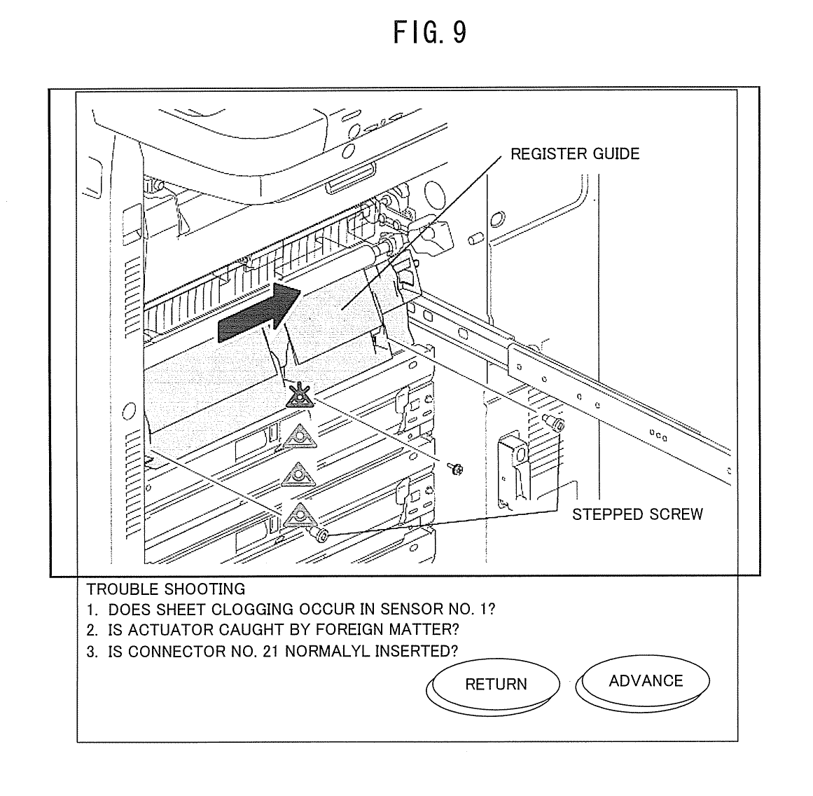

Next, the display control part 4 stands by until the sensor icon in the ON state of FIG. 7 is depressed by the person in charge of maintenance (ACT 8, No). When the sensor icon in the ON state is depressed by the person in charge of maintenance (ACT 8, Yes), the display control part 4 acquires the procedure image data by referring to the correspondence table stored in the storage part 3, and switches so that the acquired procedure image data is displayed (ACT 9). When an explanatory text of a removal procedure is also correlated and stored in the storage part 3, the display control part controls so that this text information is also displayed (ACT 10). FIG. 8 and FIG. 9 show the display examples of the UI part 6 at this time. In this embodiment, the person in charge of maintenance depresses an “advance” button or a “return” button according to the progress of the removal operation, so that the procedure image data shown in FIG. 8 or FIG. 9 is switched. Incidentally, also when the procedure image data is displayed, the display control part 4 controls so that the sensor icon is displayed at the position corresponding to the sensor, and the ON sensor is emphasized and displayed.

When the sensor ON signal from the sheet clogging detection part 5 disappears, that is, when the JAM is removed (ACT 11, Yes), the display control part 4 controls the display so that the ON state sensor icon is changed to the OFF state sensor icon, and the process is ended.

In the foregoing example, although the description is made on the assumption that the transmitted whole image data, the detailed image data, and the procedure image data are displayed to only the person in charge of maintenance authorized by the authentication part 1, the implementation may be such that they are displayed to the general user. In this case, the implementation relevant to the authentication is unnecessary. Besides, in this case, the display control part 4 causes the UI part 6 to always display the maintenance notification button at the time of display of the whole image data, the detailed image data, and the procedure image data. By adopting such implementation, also when the general user cannot remove the sheet, the maintenance notification button can be depressed at any time, and notification can be easily made to the person in charge of maintenance.

Besides, although depending on the screen size and the resolution of the UI part 6, the implementation may be such that the display area is divided, and the whole image data is displayed on one area and the detailed image data is displayed on the other area simultaneously, or the detailed image data is displayed on one area and the procedure image data is displayed on the other area simultaneously.

### Second Embodiment

Next, an example of a case where plural sensors simultaneously detect the occurrence of JAM will be described as the second embodiment.

In the second embodiment, priority is given to the respective sensors, and the display control part 4 controls so that the color of the sensor icon varies according to the priority.

Here, a method of determining the priority in this embodiment will be described. As the principle, setting is made so that the priority of the downstream side in sheet conveyance is higher than that of the upstream side. Besides, when plural sensors react on one sheet, because of the structure, there is a case where the sheet is cut out according to the direction of removing the sheet, and the removal becomes more difficult. Thus, the priority is provided such that the sheet is pulled out in a specified direction. Besides, when toner is not fixed to the sheet but is merely put on the sheet, there is a case where the toner is attached to the hand of the operator when the sheet as stated above is removed. When an operation is continuously performed by the hand to which the toner is attached, the toner is attached to another device, and it is conceivable that a defect occurs due to this. Thus, the priority of the sensor at the place where toner is not fixed to the sheet is set to be low, and the operation of the person in charge of maintenance is guided so that the sheet is removed as late as possible.

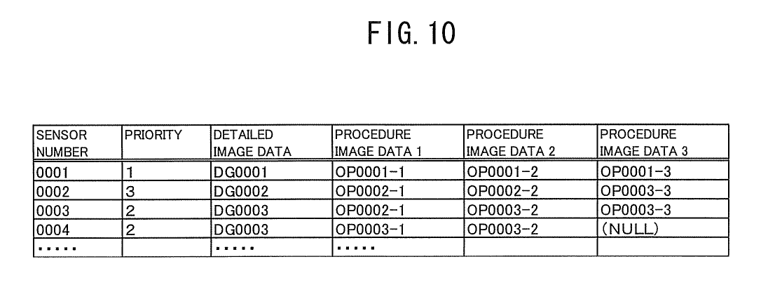

FIG. 10 shows a correspondence table stored in the storage part 3 of this embodiment. As shown in FIG. 10, in this embodiment, a column of priority is further provided to the correspondence table (the correspondence table of the sensor number, the detailed image data, and the procedure image data) described in the first embodiment, and the priority is defined for each sensor number. When plural sensors are in the ON sate, the display control part 4 compares the priorities for the respective sensor numbers of the ON state, and colors the sensor icons. In this embodiment, although the priority is indicated by the color, the implementation of indicating the priority may be such that the sensor icon having the highest priority is blinked, or the blinking speed of the sensor icon in the ON state is made different.

Besides, the display control part 4 may control such that when one sensor is changed from ON to OFF, return is not made to the whole image data each time, but the detailed image data corresponding to the ON state sensor having next higher priority is displayed.

### Third Embodiment

In a third embodiment, a method of displaying a list of sensors arranged in the image forming apparatus 100 will be described.

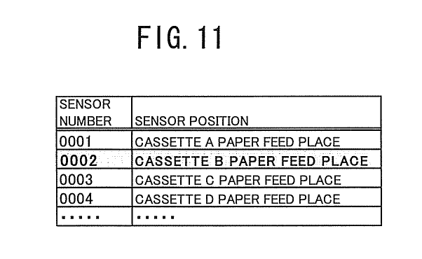

The display control part 4 causes the UI part 6 to display, for example, a sensor list shown in FIG. 11. Besides, the display control part 4 controls so that the column of the sensor which detects the occurrence of JAM is highlighted. This list is realized such that a column is further provided in the correspondence table described in the first and the second embodiments, and text data describing the respective sensor positions is registered in this column.

When the person in charge of maintenance selects a sensor from the list, the display control part 4 controls so that the detailed image data corresponding to the selected sensor is instantaneously displayed. Besides, when JAM is removed, the display control part 4 returns the highlighted display to the normal display.

Besides, there is also a case where the operation can be performed when only the position of the sensor can be specified since the person in charge of maintenance is familiar with the maintenance operation of the image forming apparatus 100. In such a case, it is conceivable that the display control part 4 controls so that only the detailed image data is displayed after the list display, and after this, the procedure image data is not displayed.

Of course, the sensor list shown in FIG. 11 may be displayed simultaneously with the apparatus whole view as shown in FIG. 6 in which the sensor icons are displayed.

### Fourth Embodiment

Next, a fourth embodiment will be described.

An image forming apparatus of the fourth embodiment includes a storage part and a display part. The storage part stores an error code as a code of a defect occurring in the image forming apparatus, an adjustment item relating to a place where the defect occurs, and a set value of the adjustment item, which are correlated with one another. The display part displays a list of error codes of defects which occur now or already occurred in the image forming apparatus, acquires adjustment items and set values, which correspond to an error code selected from the list, from the storage part, and displays them as an adjustment item list, and when an adjustment item is selected from the adjustment item list, an image in which the set value of the selected adjustment item is changed is displayed.

Here, the background and problems of the fourth embodiment will be described. Hitherto, as a unit configured to know what defects occurred in the past in an image forming apparatus, there is a function of error history in which error codes occurring in the past are stored in a storage part. This error history is useful when a person in charge of maintenance checks the image forming apparatus in a maintenance operation or the like.

However, in the error history of the related art, although it is possible to know the defects which occurred, it is difficult to instantaneously determine that an adjustment code (adjustment item) relating to which place should be confirmed and a set value of which adjustment code should be corrected in order to prevent (solve) the occurrence of the defect. From this, the person in charge of maintenance is required to work while referring to a manual or the like, and there is a case where it takes much time to solve the defect.

In the fourth embodiment, a technique is provided in which the person in charge of maintenance can easily find the adjustment code relating to the place where the defect occurs, and the set value can be easily changed.

In the fourth embodiment, in order for the person in charge of maintenance to know what defect occurs in the image forming apparatus of the maintenance object, the error history function of the related art is used, and further, the list of error codes which occurred in the past is displayed. The person in charge of maintenance sees the error history of the error codes which occurred in the past and are displayed on the control panel, and when he or she touches one of the error codes which is desired to be checked, the list of adjustment codes and set values relating to the place where the defect occurred is displayed. The person in charge of maintenance confirms the displayed adjustment codes and the set values, and can check whether there is a set value to be changed.

Further, the person in charge of maintenance confirms the set value, and when considering that the value is to be changed, the person in charge of maintenance merely touches the displayed adjustment code. Then, the image forming apparatus changes the screen to the set value change screen of the adjustment code, and the set value can be changed on the spot. By the implementation as stated above, it is possible to reduce the labor of the relate art in which adjustment codes are inputted one by one and set values are displayed while confirming through the manual or the like, and the input is made while confirming the set values.

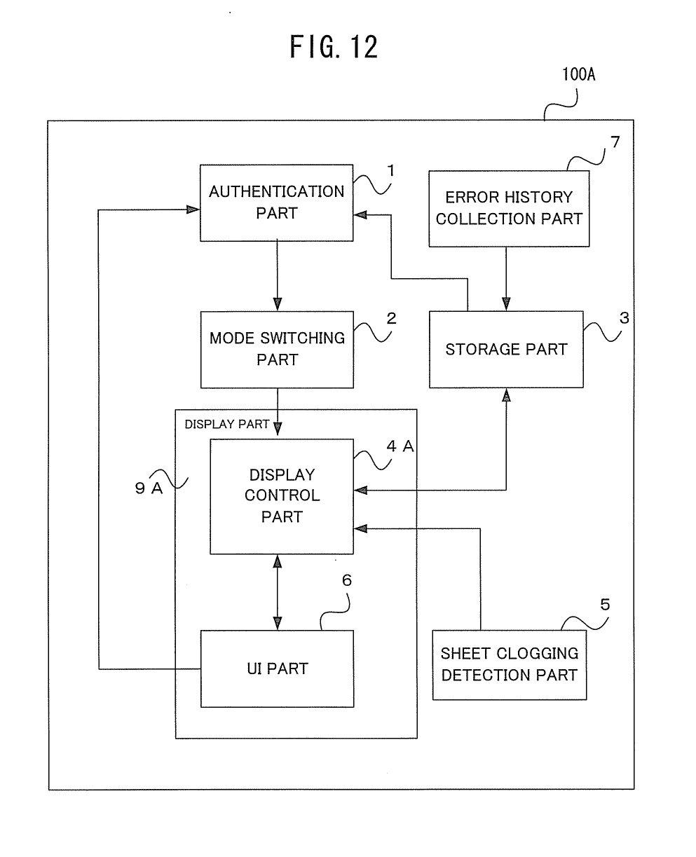

FIG. 12 shows a function block of the fourth embodiment. An image forming apparatus 100A of the fourth embodiment includes an error history collection part 7 which collects at least an error code of a defect when the defect (JAM, SC, etc.) occurs and the occurrence date, correlates them with each other and stores them in a storage part 3, in addition to the foregoing image forming apparatus 100. Besides, the image forming apparatus 100A includes a display part 9A. The display part 9A includes, in addition to the display control part 4, a display control part 4A having a function to display and control information relating to the error collected by the error history collection part 7. Incidentally, the error code, the adjustment code and the set value are correlated with one another and are stored in the storage part 3.

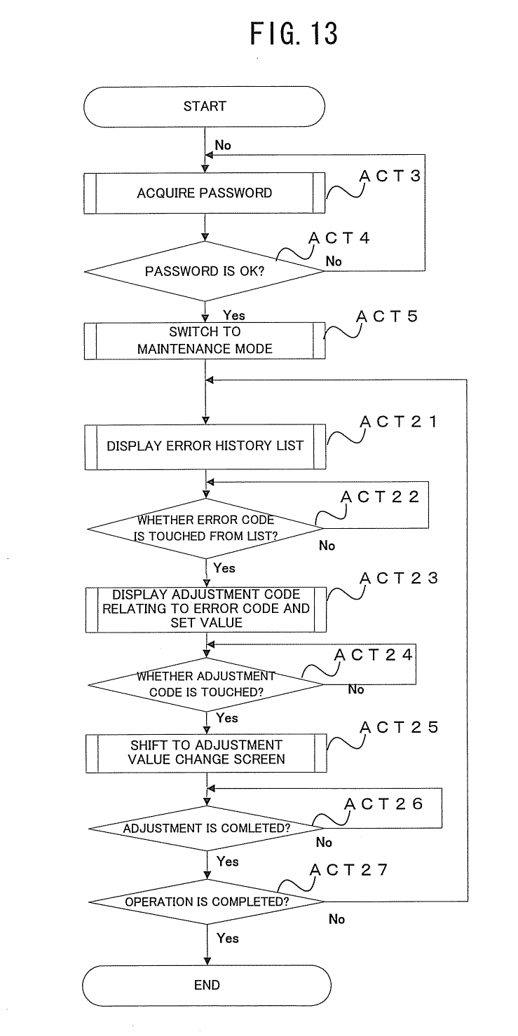

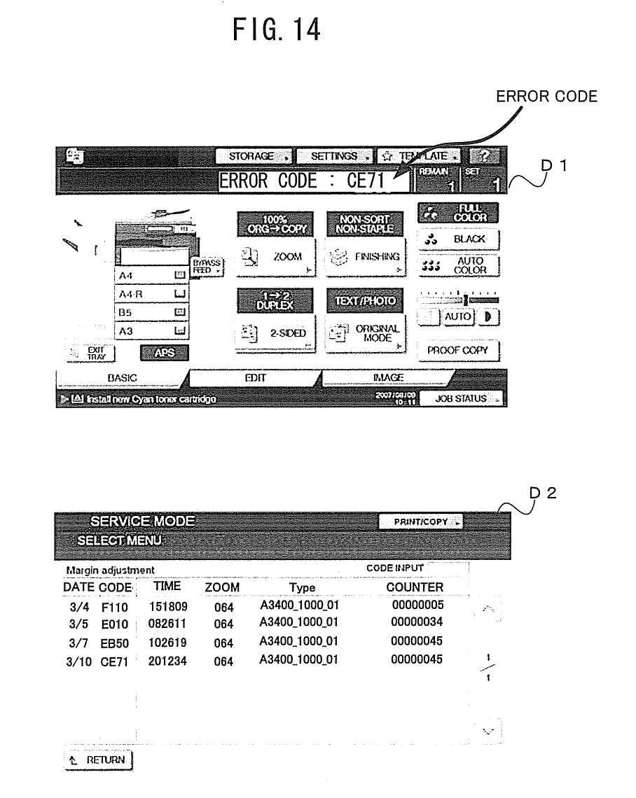

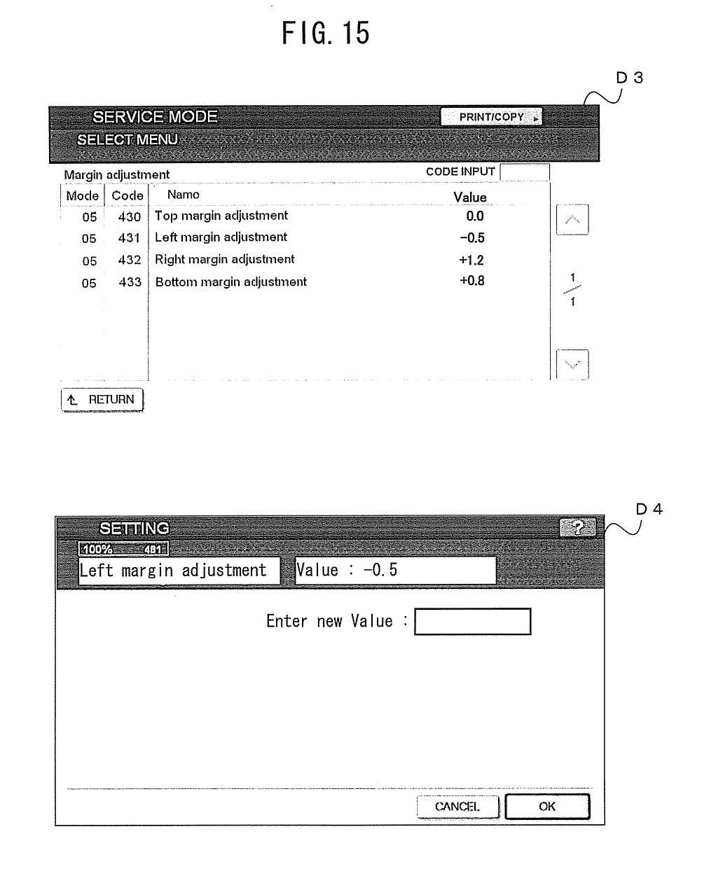

Next, the operation of the image forming apparatus 100A will be described with reference to a flowchart of FIG. 13 and display examples of FIG. 14 and FIG. 15. Incidentally, since ACT 3 to ACT 5 of FIG. 13 are the same as ACT 3 to ACT 5 of FIG. 4, their description is omitted.

After a mode is switched to a maintenance mode, the display control part 4A controls so that the display of the UI part 6 is changed from a normal screen D1 of FIG. 14 to an error code history list screen D2. Incidentally, a column in which a code of an error occurring now or most recently in the image forming apparatus 100A is displayed is provided on the management screen D1, and when a defect occurs, the relevant error code is displayed in this column.

When the person in charge of maintenance depresses the error code display column, the display control part 4A totalizes the error codes and corresponding data of occurrence date stored in the storage part 3, calculates the accumulated occurrence number for each error code, creates the code history list screen D2 (see FIG. 14) on which the accumulated occurrence number is correlated for error code, and causes the UI part 6 to display (ACT 21). Besides, the display control part 4A controls so that the newest occurrence date when the defect occurs is also correlated with the error code and is displayed.

Next, when the person in charge of maintenance depresses an objective error code (for example, an error code displayed in the error code display column of the normal screen D1) from the list displayed on the code history list screen D2 (ACT 22, Yes), the display control part 4A controls to display a list screen D3 (see FIG. 15) of the adjustment code corresponding to the error code and the set value (ACT 23). At this time, the display control part 4A controls to acquire the adjustment code and the set value from the storage part 3 based on the correspondence relation stored in the storage part 3 and to display them.

When the person in charge of maintenance depresses an adjustment code to be adjusted from the list screen D3 (ACT 24, Yes), the display control part 4A displays a screen D4 (see FIG. 15) to change the set value of the depressed adjustment code (ACT 25). The person in charge of maintenance performs the setting operation by using the screen D4 (ACT 26, ACT 27). Incidentally, the set value changed by the screen D4 is instantaneously reflected.

As described above in detail, according to the technique disclosed in this specification, the user can efficiently work while referring to the displayed screen.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus for forming an image on a sheet, comprising:
a plurality of detection parts that are respectively installed at specific positions in the image forming apparatus and respectively detect whether sheet clogging occurs;
a storage part to store data of a transmitted image of the image forming apparatus; and
a display part that acquires the data of the transmitted image of the image forming apparatus from the storage part, displays the data of the transmitted image, displays position information indicating installation places of the respective detection parts on the transmitted image, and emphasizes and displays position information corresponding to the detection part which now detects the sheet clogging.

2. The apparatus of claim 1, wherein
the storage part further stores detailed image data indicating a periphery of a place where each of the detection parts is installed,
when one of the position information displayed on the transmitted image is selected, the display part acquires the detailed image data corresponding to the detection part corresponding to the position information from the storage part, displays the detailed image data, and displays the position information on the detailed image.

3. The apparatus of claim 2, wherein
when the position information displayed on the detailed image is selected, the display part displays a procedure of removing the sheet clogging in the detection part corresponding to the position information.

4. The apparatus of claim 1, wherein
the detection parts are given priority, and
the display part varies display of the position information according to the priority.

5. The apparatus of claim 1, further comprising:
an authentication part to determine whether a specified password is inputted; and
a mode switching part to switch a normal mode to a maintenance mode when the authentication part determines that the specified password is inputted, wherein
in the maintenance mode, the display part displays the transmitted image data and the position information of the respective detection parts.

6. The apparatus of claim 1, wherein
the display part further displays a list of identification information of the detection parts.

7. The apparatus of claim 6, wherein
in the list of the identification information, the display part displays the identification information corresponding to the detection part detecting the sheet clogging, which is differentiated from other identification information.

8. The apparatus of claim 6, wherein
the storage part further stores detailed image data indicating a periphery of a place where each of the detection parts is installed,
when identification information is selected from the list of the identification information, the display part acquires and displays the detailed image data indicating the periphery where the detection part corresponding to the identification information is arranged from the storage part, and displays the position information of the detection part on the detailed image.

9. The apparatus of claim 2, wherein
the detailed image data is a transmission view of the image forming apparatus.

10. The apparatus of claim 1, wherein
the display part includes a touch panel display, and displays the transmitted image data and the position information on the touch panel display.

11. An image forming apparatus for forming an image on a sheet, comprising:
a storage part to store an error code as a code of a defect occurring in the image forming apparatus, an adjustment item relating to a place where the defect occurs, and a set value of the adjustment item, which are correlated with one another; and
a display part that displays a list of error codes of defects occurring now or already occurring in the image forming apparatus, acquires adjustment items and set values, which correspond to an error code selected from the list, from the storage part, displays them as an adjustment item list, and displays, when an adjustment item is selected from the adjustment item list, an image to change the set value of the selected adjustment item.

12. The apparatus of claim 11, wherein
the display part displays the error codes of the defects occurring now or most recently in a specified column, and when the specified column is selected, the display part displays the list of the error codes.

13. A display control method of an image forming apparatus, comprising:
detecting, by a plurality of detection parts respectively installed at specific positions in the image forming apparatus, whether sheet clogging occurs;
acquiring, by a controller in the image forming apparatus, data of a transmitted image of the image forming apparatus from a storage part, controlling to display the data of the transmitted image, displaying position information indicating installation places of the respective detection parts on the transmitted image, and emphasizing and displaying position information corresponding to the detection part which now detects the sheet clogging.

14. The method of claim 13, wherein
when one of the position information displayed on the transmitted image is selected, the controller acquires detailed image data indicating a periphery of an installation place of the detection part corresponding to the position information from the storage part, controls to display the detailed image data, and controls to display the position information on the detailed image.

15. The method of claim 14, wherein
when position information displayed on the detailed image is selected, the controller controls to display a procedure of removing the sheet clogging in the detection part corresponding to the position information.

16. The method of claim 13, wherein
the detection parts are given priority, and
the controller controls to vary display of the position information according to the priority.

17. The method of claim 13, further comprising:
by the controller,
determining whether a specified password is inputted;
switching a normal mode to a maintenance mode when it is determined that the specified password is inputted; and
controlling to display the transmitted image data and the position information of the respective detection parts in the maintenance mode.

18. The method of claim 13, wherein
the controller further controls to display a list of identification information of the detection parts.

19. The method of claim 18, wherein
in the list of the identification information, the controller controls to differentiate display of the identification information corresponding to the detection part detecting the sheet clogging from display of other identification information.

20. The method of claim 18, wherein
when identification information is selected from the list of the identification information, the controller acquires detailed image data indicating a periphery where the detection part corresponding to the identification information is arranged from the storage part, controls to display the detailed image data, and controls to display the position information of the detection part on the detailed image.
